(19) United States
(12) Patent Application Publication
(10) Pub. No.: US 2015/0251909 A1
(43) Pub. Date: Sep. 10, 2015

(54) METHOD FOR PRODUCING THE LITHIUM IRON PHOSPHATE

(71) Applicants: Mikhail Alexandrovich Arkhipov, Alexandrov (RU); Mukhamed Magomedovich Arsanukaev, Alexandrov (RU); Sergey Stepanovich Kovalev, Alexandrov (RU); Vladimir Fedorovich Shitsle, Alexandrov (RU); Vladimir Anatol'evich Muhanov, Alexandrov (RU); Alexander Ivanovich Motchanii, Alexandrov (RU); Olga Viktorovna Solovyova, Alexandrov (RU)

(72) Inventors: Mikhail Alexandrovich Arkhipov, Alexandrov (RU); Mukhamed Magomedovich Arsanukaev, Alexandrov (RU); Sergey Stepanovich Kovalev, Alexandrov (RU); Vladimir Fedorovich Shitsle, Alexandrov (RU); Vladimir Anatol'evich Muhanov, Alexandrov (RU); Alexander Ivanovich Motchanii, Alexandrov (RU); Olga Viktorovna Solovyova, Alexandrov (RU)

(73) Assignee: MINERAL LTD., Alexandrov (RU)

(21) Appl. No.: 14/201,927

(22) Filed: Mar. 10, 2014

(51) Int. Cl. C01B 25/45; H01M 4/58

(52) U.S. Cl. CPC C01B 25/45; H01M 4/5825; H01M 2004/028

(57) ABSTRACT

The invention describes the chemical technology for producing cathode materials for lithium-ion batteries.

The object of this invention is to develop a simple, clean and less expensive method for producing a highly dispersed composite cathode materials based on lithium iron phosphates with a high specific product yield per reaction volume unit.

The stated technical problem is solved due to the fact that in the process for producing the lithium iron phosphate comprising a mixing an iron compound with iron oxidation number in the range of +2.03÷+2.2 with the aqueous solution containing lithium and phosphate ions in the presence of carbonaceous reductant material, activating the mixture obtained to form a gel, and subsequent thermal treatment of the gel.

The present invention relates to the chemical technology for producing cathode materials for lithium-ion batteries.

The use of compounds with olivine-type structure, LiFePO₄ particularly, having a high theoretical value of the capacitance (up to 170 mA·h/g), low cost, non-toxicity, explosion and fire safety, high thermal and charge-discharge stability as materials in lithium-ion batteries is known from the prior art.

The use of LiFePO₄ obtained by solid phase synthesis of solid mixture of Li₂CO₃ or LiOH.H₂O, Fe(CH₃COO)₂, and NH₄H₂PO₄.H₂O at a temperature of above 800° C. in argon atmosphere as a cathode material in lithium-ion batteries was described for the first time in Padhi A. K. et. al. J. Electrochem. Soc., vol. 144 (1997), p.p. 1609-1613.

The processes for producing the lithium iron phosphate by solid phase reactions, carbothermal reduction, and mechanochemical activation are known from the prior art.

U.S. Pat. No. 7,964,308 B2 describes process for producing LiFePO₄ by mixing of Li₂CO₃ or LiOH.H₂O, Fe(CH₃CO₂)₂, and NH₄H₂PO₄.H₂O. The solid mixture was annealed at temperatures between 300 and 350° C. to remove NH₃, H₂O and CO₂. Then the mixture was further treated in an argon atmosphere for 24 hours at 800° C. In U.S. Pat. No. 7,964,308 B2, it is also mentioned a process for producing the LiFePO₄ by annealing the ground mixture containing Li₂C₂O₄, LiH₂PO₄, and Fe(C₂O₄).2H₂O.

U.S. Pat. No. 6,702,961 B2 discloses the process for producing LiFePO₄ by granulating the ground mixture containing FePO₄, Li₂CO₃ and carbon and further annealing the mixture obtained in inert atmosphere at temperature of 700° C. for 8 hours.

U.S. Pat. No. 7,371,482 B2 discloses the process for producing LiFePO₄, comprising several stages: providing an equimolar aqueous solution of Li¹⁺, Fe³⁺ and PO₄³⁻, evaporating water from the solution to produce a solid mixture, decomposing the solid mixture at a temperature of below 500° C. to form a pure homogeneous Li and Fe phosphate precursor, and annealing the precursor at a temperature of less than 800° C. in a reducing atmosphere to produce the LiFePO₄ powder.

A process for producing the lithium iron phosphate by heating of equimolar mixture of lithium carbonate, iron oxalate, and ammonium dihydrogen phosphate powders at the temperatures between 700 and 800° C. in an inert atmosphere is known from the prior art (Chen H. et. al Bull. Mater. Sci., vol. 29, no. 7 (2006), p.p. 689-692):

0.5Li₂CO₃+FeC₂O₄.4H₂O+NH₄H₂PO₄═LiFePO₄+NH₃+CO+1.5CO₂+5.5H₂O

Processes for producing the lithium iron phosphate by solid phase chemistry methods have the common drawback that the lithium iron phosphate is formed as a compact sinter and it should be crushed up to a particle size of 0.2÷0.5 μm for further use. Other drawbacks are high consumption of protection gas during the sintering process, and the high cost of initial chemicals.

The closest to the proposed technical solution is a method of producing the lithium iron phosphate by the reacting in stoichiometric ratio of lithium hydroxide, ferrous sulphate and phosphoric acid solutions with a small amount of ascorbic acid according to the chemical reaction:

3LiOH.H₂O+FeSO₄.7H₂O+H₃PO₄═LiFePO₄+12H₂O+Li₂SO₄.H₂O

with the further hydrothermal treatment of the obtained product. This was described in U.S. Pat. No. 7,998,618 B2 disclosing the use of expensive iron sources with iron oxidation number +2 for making precursor mixture.

The drawbacks of the method (U.S. Pat. No. 7,998,618 B2) are the following: the use of expensive iron compounds with iron oxidation number +2, a small specific yield of lithium iron phosphate because of the large quantity of byproducts which should be utilized. Besides, it predetermines a substantially greater consumption of lithium ions compared to our invention. It is written in U.S. Pat. No. 7,998,618 B2: “In the context of the present invention, the term conversion of the precursor mixture under hydrothermal conditions is to be understood as meaning any treatment at a temperature above room temperature and steam pressure of above 1 bar”. However, according to our invention treatment is done not in steam, but in water phase. Quantity of precursor mixture to be placed in autoclave and temperature of hydrothermal treatment in autoclave must be chosen so that raw materials and produced lithium iron phosphate remain all time of hydrothermal treatment in water phase according to our invention. It is important to avoid lithium iron phosphate hydroxide appearance as byproduct.

In the present invention iron oxide with the iron oxidation number in the range of +2.03÷ +2.2 is used as an iron source which is cheaper and gives no byproduct (Li₂SO₄.H₂O) requiring further recycling after lithium iron phosphate synthesis.

The main technical aim of the invention is to create a simple, rapid and less expensive method for producing a highly dispersed composite cathode materials based on lithium iron phosphates with high specific product yield per reaction volume unit.

The declared technical aim is achieved by the process for producing the lithium iron phosphate comprising a mixing in a stoichiometric ratio an iron compound with the aqueous solution containing lithium and phosphate ions in the presence of carbonaceous material, activating the mixture obtained, and subsequent thermal treatment of the reaction product, the iron oxide powder with iron oxidation number in the range of +2.03÷+2.2 with particle size up to 125 μm is being used as iron compound mixed with the aqueous lithium dihydrogen phosphate with concentration of 30-57 wt. %, and activating the mixture obtained by mechanical agitation carried out at the temperatures between 15 and 30° C. till the gel is formed.

The reason to use the iron oxide with iron oxidation number in the range of +2.03÷+2.2 is the thermodynamic instability of divalent iron oxide. Therefore it is almost impossible to use divalent iron oxide in mass production because of commercial unavailability of this reagent. Iron oxide with iron oxidation state of +2.0 is almost impossible to obtain in an industrial scale but there is commercial production of the reagent FeO₁₊ₓ, where x=0.015-0.100, that is, with the oxidation state of +2.03÷+2.2.

The mixing the iron oxide with an aqueous solution of lithium dihydrogen phosphate and carbon reducing agent (e.g., ascorbic acid) leads to their interaction, and, hence, each particle of iron oxide is being coated with LiFePO₄(OH)ₓ layer according to the reaction:

FeO₁₊ₓ+LiH₂PO₄═LiFePO₄(OH)₂ₓ+(1−x)H₂O

with a few layers of a concentrated solution of lithium dihydrogen phosphate (LiH₂PO₄) between the particles. Complete reaction of the iron oxide occurs in the heat treatment of the gel in an autoclave.

Reduction of ascorbic acid is in an autoclave at heat treatment according to the reaction:

LiFePO₄(OH)₂ₓ+0.1xC₆H₈O₆═LiFePO₄+0.6xCO₂+1.4xH₂O

Iron oxide particles with a size up to 125 μm ensure the completeness of their reaction with solution. The iron oxide particles with a size over 125 μm are not completely reacted, while reducing the yield of the desired product.

It is necessary to note that if x is more than 0.1 the recovery process is not fully completed: in the reaction product there is a considerable amount of lithium iron phosphate hydroxide along with the lithium iron phosphate despite the excess of reducing agent.

In the proposed method an aqueous solution of lithium dihydrogen phosphate is used as the source of lithium and phosphate ions. The concentration of lithium dihydrogen phosphate was empirically chosen and was equal 30-57 wt. %. It was found to be the optimum concentration for obtaining the highest yield of the target product. When the concentration is below 30 wt. % the product is badly obtained, the separation of the reaction mass is occurred, and the iron oxide particles are caked. It leads to decrease in the yield of the final product and the concentration of 57 wt. % is the maximum one for lithium dihydrogen phosphate at 20° C.

The temperatures of the mechanical activation of a mixture between 15 and 30° C. were empirically chosen and it was found to be the optimal temperature for the chemical reaction of the components which are included in a mixture composition. At the temperatures below 15° C. there is almost no interaction between the components. At the temperatures above 30° C. the reaction proceeds too quickly: the oxide particles are coalesced into large agglomerates which are not completely reacting with LiH₂PO₄, and it results in reduced yield of the target product. When mixing the mixture is thickened and eventually turns into a dense gel. Activation of mixture is carried out until the gel is obtained. The product of this state is placed into the autoclave. The very tight filling without pores and voids is obtained. The further thermal treatment of the product causes a receiving of submicron crystalline lithium iron phosphate powder with a yield of 1.05 g per 1 cm³ of reaction volume. Further, the gel is heat treated in a sealed autoclave.

The achieved technical result obtained by the inventive process leads to a simplification and expenses decreasing of the synthesis process of lithium iron phosphate in an autoclave at increasing of specific product yield per reaction volume unit.

### EXAMPLES

### Example 1

Iron oxide powder with iron oxidation number of +2.2 with particle size of 125 μm in the amount of 294.4 g was mixed with 732 g of aqueous lithium dihydrogen phosphate of concentration of 57 wt. % in the presence of 72 g of ascorbic acid. The resulting suspension was subjected to mechanical activation by mixing at a temperature of 20° C. to form a reaction product in the form of a gel (within 30 minutes). 1098.4 g of the product was obtained. This product was placed in an autoclave of 600 cm³ and tightly filled the autoclave without pores and voids. The pre-sealed autoclave contents were subjected to heat treatment at a temperature of 250° C. 632 g of lithium-iron-phosphate was received. After cooling, the autoclave was opened; the substance was removed, filtered and subjected to drying. Specific yield was 1.05 g per 1 cm³.

### Example 2

The process was similar to Example 1, wherein the iron oxide powder size was 160/125 μm. Iron oxide is not completely reacted. 226.2 g of lithium iron phosphate was received. The yield of lithium iron phosphate was 0.377 g per 1 cm³ of autoclave.

### Example 3

The process was similar to Example 1, wherein 1387 g of 30% aqueous solution of lithium iron phosphate was used. 1753 g of the mixture was obtained. The mixture was placed in an autoclave of 1264 cm³ in volume. After the thermal treatment, 632 g or 0.50 g per 1 cm³ of autoclave of lithium iron phosphate was obtained.

### Example 4

The process was similar to Example 1, wherein the iron oxide powder was mixed with 1605 g of 26% aqueous solution of lithium dihydrogen phosphate. After mixing the dense state was not received. When loading the 2019.4 g of gel into the autoclave of 1500 cm³ in volume the mixture was laminated. The part of iron oxide did not react. The yield of lithium iron phosphate was 319.5 g or 0.213 g per 1 cm³.

### Example 5

The process was similar to Example 1, wherein the mechanical activation of mixture was carried out at a temperature of 13° C. for 2 hours. The mixture was not thickened. When loading into the autoclave the iron oxide precipitated. The yield of lithium iron phosphate was 66 g or 0.11 g per 1 cm³ of autoclave.

### Example 6

The process was similar to Example 1, wherein the mechanical activation of mixture was carried out at a temperature of 33° C. The mixture is largely clumped. The yield of lithium iron phosphate was 225 g or 0.375 g per 1 cm³ of autoclave.

### Example 7

The process was similar to Example 1, wherein 296 g of iron oxide of FeO_{1,125} composition (oxidation number is +2.25) and 125 g of ascorbic acid was used. 1153 g of the mixture was obtained. The mixture was placed in an autoclave of 650 cm³ in volume. 649 g of the product was received. According to the Mössbauer spectroscopy and X-ray phase analysis data, the product is a mixture of LiFePO₄ and LiFePO₄(OH) in the approximate weight ratio of 3:1.

What is claimed is:

1. A process for producing the lithium iron phosphate, comprising following steps:
a) formation of precursor mixture comprising at least iron compound having iron oxidation number in the range of +2.03÷+2.2 and at least the aqueous solution having Li⁺ and PO₄³⁻ sources in the presence of carbonaceous reductant material;
b) activating the precursor mixture by mechanical agitator;
c) synthesis of LiFePO₄ by treatment of the precursor mixture in autoclave at temperature above 100° C. in water phase;

2. The process according to claim 1, wherein the iron oxide powder is used as iron compound.

3. The process according to claim 1, wherein the particle size of iron oxide powder not more than 125 μm.

4. The process according to claim 1, wherein aqueous solution contain lithium dihydrogen phosphate.

5. The process according to claim 4, wherein the concentration of the aqueous lithium dihydrogen phosphate is 30-57 wt. %.

6. The process according to claim 1, wherein the activating is performed at the temperature between 15 and 30° C.

7. The process according to claim 1, wherein the agitation is finished when the whole aqueous solution become gel.

8. The process according to claim 1, wherein the Li₂CO₃ is used as a lithium ion source.

9. The process according to claim 1, wherein the phosphoric acid is used as PO₄³⁻ source.

10. The process according to claim 1, wherein the carbonaceous material contain ascorbic acid.
